(19) United States
(12) Patent Application Publication
(10) Pub. No.: US 2018/0321822 A1
(43) Pub. Date: Nov. 8, 2018

(54) SYSTEMS AND METHODS FOR SELECTION AND OPERATION ON MULTIPLE GROUPS OF LAYOUT OBJECTS VIA A GRAPHIC-BASED LAYOUT EDITOR

(71) Applicant: SKILLCAD, INC., San Jose, CA (US)

(72) Inventor: Pengwei QIAN, San Jose, CA (US)

(21) Appl. No.: 15/589,952

(22) Filed: May 8, 2017

(51) Int. Cl. G06F 3/0484; G06T 11/60; G06F 17/50

(52) U.S. Cl. CPC G06F 3/04842; G06F 3/04845; G06F 2217/06; G06F 17/5072; G06T 11/60

(57) ABSTRACT

A new approach is proposed to support selection and operation on multiple groups of layout objects via a graphic-based layout editing tool. The layout editing tool presents groups of layout objects in a layout on a display of the host, wherein each group comprises one or more layout objects sharing the same or similar topology in the layout. The layout editing tool enables a user to select at least two groups of layout objects by directionally and continuously moving a cursor across each group of layout objects along a respective directed single line, wherein each directed single line intersects with and selects one section of a group of layout objects. The layout editing tool then performs a layout operation on the sections of the one or more groups of layout objects all at once based on metadata and/or one or more design rules associated with the groups of layout objects.

### BACKGROUND

A graphic-based layout editing tool/editor is software running on a hosting device or host, wherein the graphic-based layout editor presents a layout to a user/designer on a display screen of the host and enables the user to interactively generate and edit the layout via input devices associated with the host. Here, the layout typically includes hundreds or even thousands of layout objects of various shapes and sizes, including but not limited to blocks, cells, gates, interconnect wires, etc. The layout can be, for non-limiting examples, for an integrated circuit (IC) design or an architectural design.

Each layout object in the layout typically has metadata associated with it, wherein such metadata includes, for non-limiting examples, name, geometric properties (e.g., length, width, size, shape or topology, orientation, spacing, and connections with other layout objects of the layout) and design rules (e.g., permissible positions, minimum or maximum lengths, widths, and spacing from other layout objects) each layout object needs to follow in the layout. A group of layout objects in a layout may share the same or similar shape/topology in the layout. For a non-limiting example, a bus in an IC layout comprises one or more interconnect wires following the same or similar topology, wherein each interconnect wire includes one or more interconnect wire segments on one or more layers with vias connecting the wire segments across the layers. During editing of the layout, certain layout operations need to be performed between layout objects belonging to one or different groups of layout objects, wherein such operation can be, for a non-limiting example, connecting interconnect wires in one bus with corresponding interconnect wires in another bus. It would be cumbersome, however, to perform such layout operation between each individual layout object in the respective groups of layout objects one at a time following a certain set of design rules, especially when the number of the layout objects in each group is large. It is thus desirable to have a graphic-based layout editor that can perform layout operations among layout objects in multiple groups of layout objects all at once.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system to support selection and operation on multiple groups of layout objects in accordance with some embodiments.

FIG. 2 depicts a non-limiting example of an IC layout having two buses each having a plurality of interconnect wires of the same topology as shown on a display of a host in accordance with some embodiments.

FIG. 3A depicts an example of a directional and continuous cursor movement by the user along a first directed single line across a layout to select a first bus of five interconnect wires, wherein the first single line intersects with and selects one ending section of the first bus in accordance with some embodiments.

FIG. 3C depicts an example of a bus connecting operation, which connects the corresponding interconnect wires at the selected ending sections of the first and the second buses as shown in FIGS. 3A and 3B together in the same order as the interconnect wires are selected in accordance with some embodiments.

FIG. 3D depicts an example of a bus connecting operation, which connects the corresponding interconnect wires at the selected ending sections of the first and the second buses as shown in FIGS. 3A and 3B together in the reverse order as the interconnect wires are selected in accordance with some embodiments.

FIG. 3E depicts an example of a bus connecting operation, which connects the corresponding interconnect wires at the selected ending sections of the first and the second buses as shown in FIGS. 3A and 3B together based on net names of the interconnect wires in accordance with some embodiments.

FIG. 4A depicts an example of two buses selected by directional and continuous cursor movements by the user, wherein the second bus is selected by a diagonal single line unparalleled to the horizontal or vertical direction in accordance with some embodiments.

FIG. 4B depicts an example of connecting the two buses at an arbitrary angle or orientation with respect to each other as shown in FIG. 4A together on different or the same layer in accordance with some embodiments.

FIG. 5A depicts an example of a first group of layout objects selected by a directional and continuous cursor movement by the user along a directed single line across a layout, wherein the single line intersects with and selects one ending section of the bus in accordance with some embodiments.

FIG. 5B depicts an example of an alignment operation, which aligns all layout objects at the selected ending section of the first bus as shown in FIG. 5A at the same time with respect to the reference layout object in the second group at a minimum spacing required by design rules in accordance with some embodiments.

FIG. 5C depicts an example of an alignment operation in the opposite direction wherein the first bus is “pushed away” from the reference layout object in the second group with spacing between the two groups increasing from the minimum spacing to a spacing specified by the user in accordance with some embodiments.

FIG. 6A depicts an example of a first group of layout objects having extra wires extended beyond a second group of layout objects at the selected ending section of the second group in accordance with some embodiments.

FIG. 6B depicts an example of a trimming operation at the selected ending section of all layout objects in the first group shown in FIG. 6A at the same time to trim off the extra wires to the corresponding positions of the vias in the second group in accordance with some embodiments.

FIG. 6C depicts an example of extending the selected ending section of all layout objects in the first group at the same time to a certain length beyond the corresponding positions of the reference vias in the second group, wherein the length of the extension is either as required by design rules or as specified by the user in accordance with some embodiments.

FIG. 7A depicts an example of an open space in the layout selected by a directed single line as the reference point for the first bus to which a layout operation is to be performed in accordance with some embodiments.

FIG. 7B depicts an example of an alignment operation at all layout objects in the first bus at the same time to align the selected ending section of the first bus with respect to the selected reference point of open area in the layout depicted in FIG. 7A in accordance with some embodiments.

FIG. 7C depicts an example of an open space in the layout selected by a diagonal single line as the reference point for the first bus to which a layout operation is to be performed in accordance with some embodiments.

FIG. 7D depicts an example of an alignment operation at all layout objects in the first bus at the same time to align the selected ending section of the first bus with respect to the diagonally selected reference open area in the layout at either a minimum spacing required by design rules or a spacing specified by the user in accordance with some embodiments.

FIG. 8A depicts an example of a selection of a first section of a bus via a first directed single line of directional and continuous cursor movement across the bus in accordance with some embodiments.

FIG. 8B depicts an example of a selection of a second section of the bus depicted in FIG. 8A via a second directed single line of directional and continuous cursor movement across the bus in accordance with some embodiments.

FIG. 8C depicts an example of a wire replacing or “bridging” operation between the two selected sections of the bus as shown in FIGS. 8A and 8B by replacing the existing interconnect wire segments and vias between the two selected sections with a new set of interconnect wire segments and/or vias in accordance with some embodiments.

FIG. 9 depicts an example of a “bridging” operation performed between the first and the second selected sections of a bus only on odd-ranked interconnect wires in the bus in accordance with some embodiments.

FIG. 10 depicts an example of a flowchart of a process to support selection and operation on multiple groups of layout objects in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support selection and operation on multiple groups of layout objects via a graphic-based layout editing tool running on a host. Specifically, the graphic-based layout editing tool presents one or more groups of layout objects in a layout on a display of the host, wherein each group comprises one or more layout objects sharing the same or similar shape/topology in the layout. The layout editing tool enables a user to select at least two groups of layout objects by directionally and continuously moving a cursor across each group of layout objects along a respective directed single line, wherein each directed single line intersects with and selects one section of a group of layout objects. The graphic-based layout editing tool then performs a layout operation on the sections of the one or more groups of layout objects all at once based on retrieved metadata and/or one or more design rules associated with the groups of layout objects from a layout database.

Under the proposed approach, the layout editing tool enables the user to select sections of multiple groups of layout objects in the layout by moving the cursor continuously across the groups of layout objects in directed single lines, which simplifies the selection of the groups of layout objects. The layout editing tool is further able to perform a layout operation on the layout objects at the selected sections of the groups of layout objects all at once instead of one layout object at a time. As such, the proposed layout editing tool enables the user to operate on multiple layout objects in the each of the groups in one single operation, which greatly improves the efficiency of layout operation on the groups of layout objects.

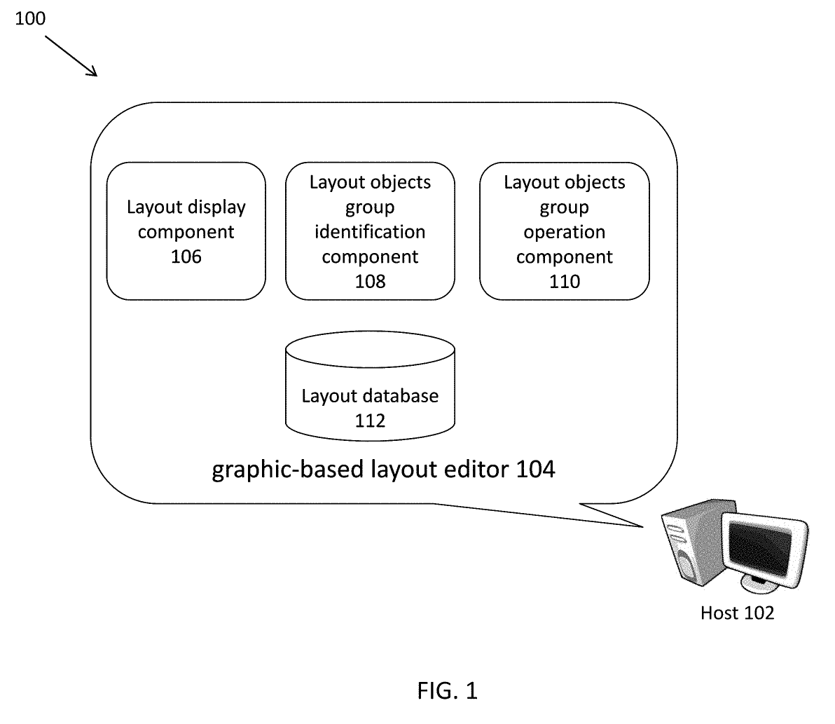

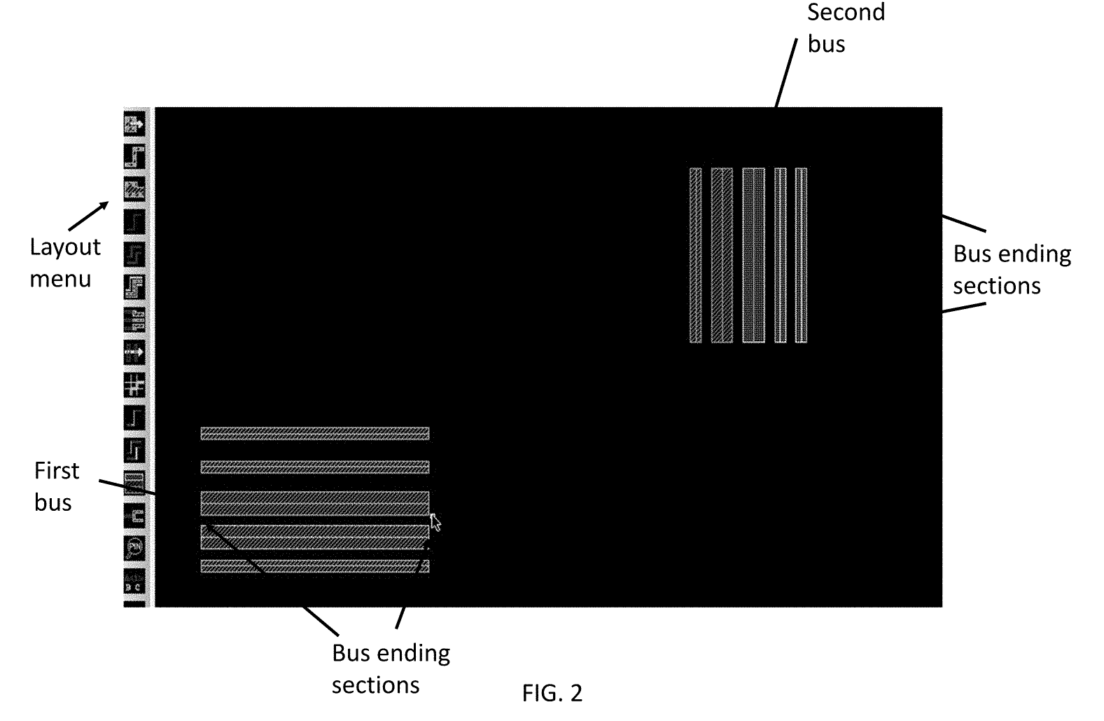

FIG. 1 depicts an example of a diagram of a system 100 to support selection and operation on multiple groups of layout objects. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, wherein the multiple hosts can be connected by one or more networks.

In the example of FIG. 1, the system 100 includes a graphic-based layout editor/editing tool/editing software 104, wherein the graphic-based layout editor 104 includes at least a layout display component 106, a layout objects group identification component 108, a layout objects group operation component 110, and a layout database 112. Here, the graphic-based layout editor 104 runs on a computing unit/appliance/host 102 having a display, one or more processors, storage units, network interfaces and having software instructions stored in a storage unit such as a non-volatile memory (also referred to as secondary memory) of the computing unit for practicing one or more processes. When the software instructions are executed, at least a subset of the software instructions is loaded into memory (also referred to as primary memory) by one of the computing units of the computing unit, which becomes a special purposed one for practicing the processes. The processes may also be at least partially embodied in the host into which computer program code is loaded and/or executed, such that, the host becomes a special purpose computing unit for practicing the processes. Here, the host can be a computing device, a communication device, a storage device, or any computing device capable of running a software component. For non-limiting examples, a computing device can be, but is not limited to, a laptop PC, a desktop PC, a tablet PC, or an x86 or ARM-based server running Linux or other operating systems. In some embodiments, the host has a communication interface (not shown), which enables the components and/or the database running on the host to communicate with software running on other hosts over one or more communication networks (not shown) following certain communication protocols, such as TCP/IP, http, https, ftp, and sftp protocols. The communication networks can be, but are not limited to, internet, intranet, wide area network (WAN), local area network (LAN), wireless network, Bluetooth, WiFi, and mobile communication network. The physical connections of the network and the communication protocols are well known to those of skill in the art.

In the example of FIG. 1, the layout display component 106 of the graphic-based layout editor 104 is configured to retrieve a layout having one or more layout objects groups each having a plurality of layout objects sharing the same or similar topology in the layout from the layout database 112 and present the layout on a display device of the host of the graphic-based layout editor 104 for a user to view and edit interactively. Here, the layout database 112 is configured to maintain metadata and/or design rules associated with each of the layout objects in the layout as well as other related information of the layout. Each of the layout objects is of certain geometric shape/topology and size, which, for non-limiting examples, can be a rectangle, a circle, a polygon, etc. In the non-limiting example of an IC layout having multiple layers, the layout objects can be cells, gates, interconnect wires, and vias of different material types (e.g., metal and polysilicon) on one or more layers and can be presented accordingly by the layout display component 106. A plurality of layout objects sharing the same or similar topology and/or geometric properties may be identified collectively as a group of layout objects, such as a bus in an IC layout, wherein the bus includes one or more interconnect wires each including a plurality of interconnect wire segments on one or more layers connected by vias. Each bus has two ending or terminating sections/points/headers at which all of its interconnect wires end/terminate. Other sections of the groups of layout objects between the ending sections can also be identified. FIG. 2 depicts a non-limiting example of an IC layout having two buses each having a plurality of interconnect wires of the same topology with different widths and spacing between them as shown by the layout display component 106 on a display of a host. FIG. 2 also depicts a menu of layout operations presented by the layout display component 106 to the user, who may selectively perform one or more layout operations on the presented buses via the menu of layout operations.

In some embodiments, each of the layout objects in a group of layout objects may have metadata associated with it, wherein the metadata includes, for non-limiting examples, one or more of name, identifier, and geometric properties (e.g., length, width, size, shape or topology, orientation, spacing, and connections with other layout objects) of the layout. In the case of an IC design layout object, the layout object may further include various design rules required for the layout object, wherein such design rules may include, for non-limiting examples, one or more of minimum and/or maximum width and/or length of the layout object, minimum and/or maximum spacing between the layout object and its adjacent layout objects, and a specific layer the layout object needs to be placed. In some embodiments, the design rules are pre-defined for the layout object based on its properties. In some embodiments, the design rules can be dynamically adjusted by the user via the graphic-based layout editor 104 during editing of the layout.

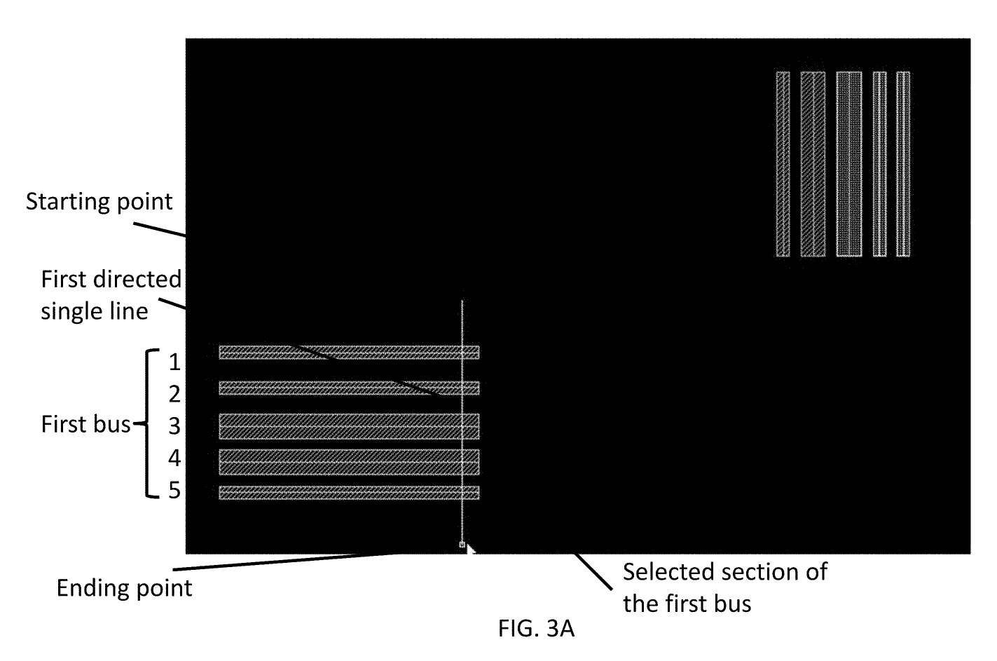

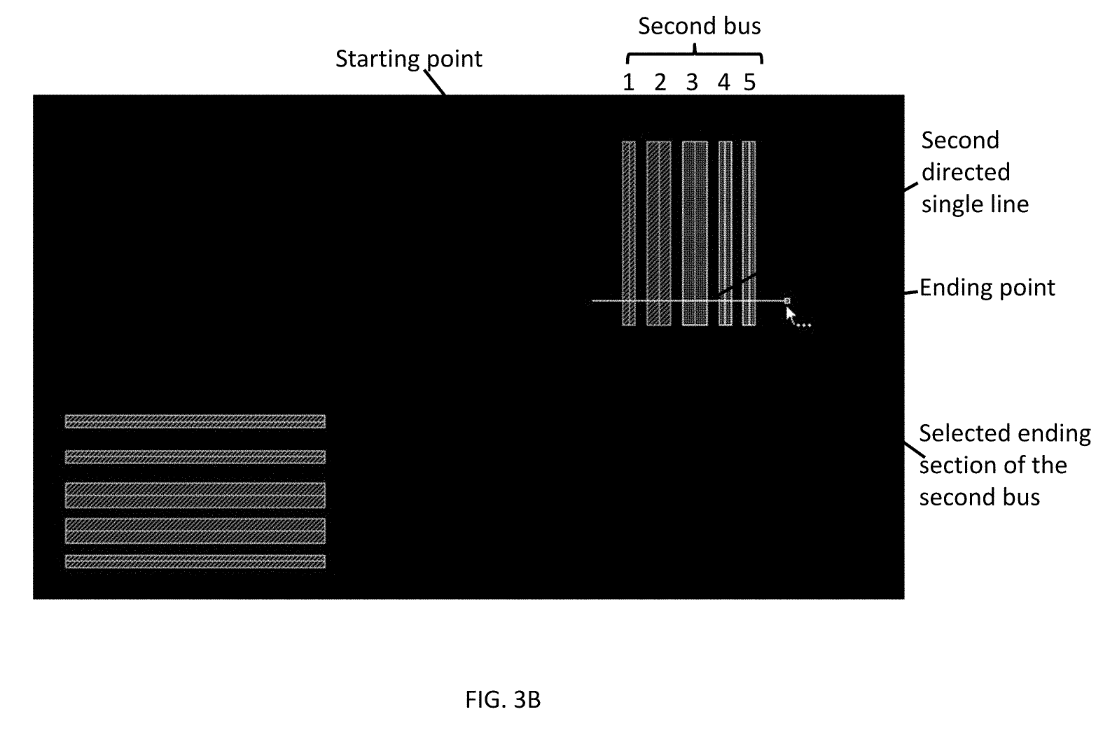

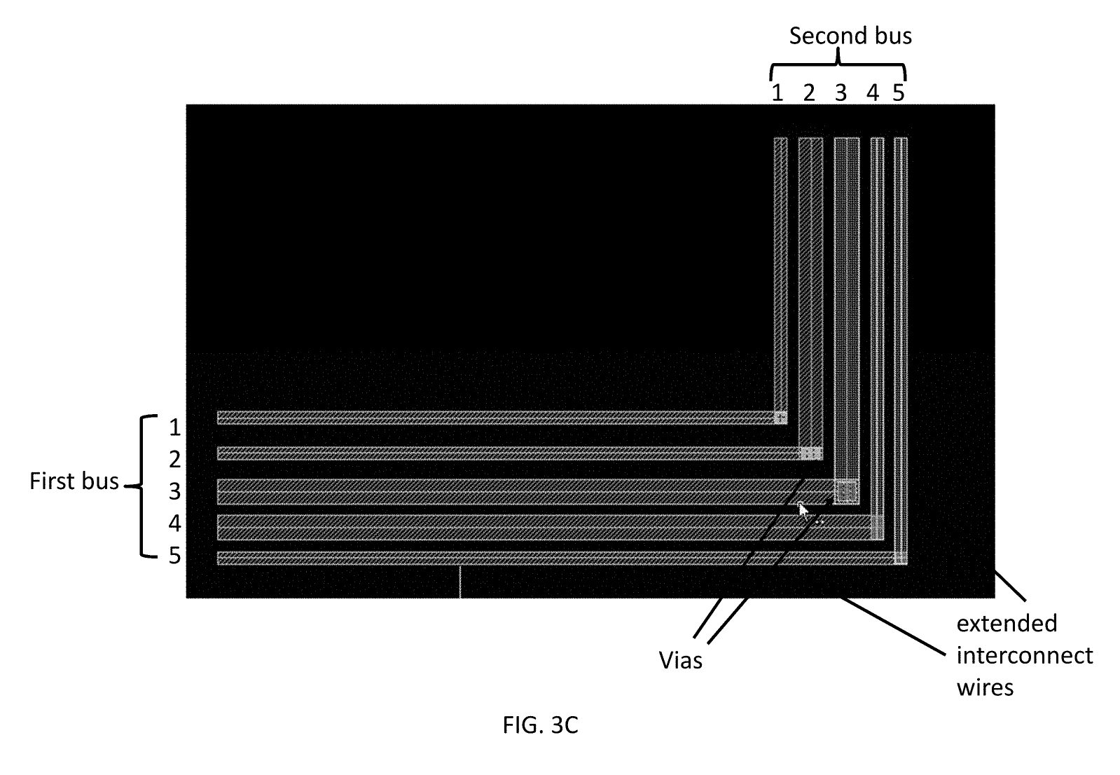

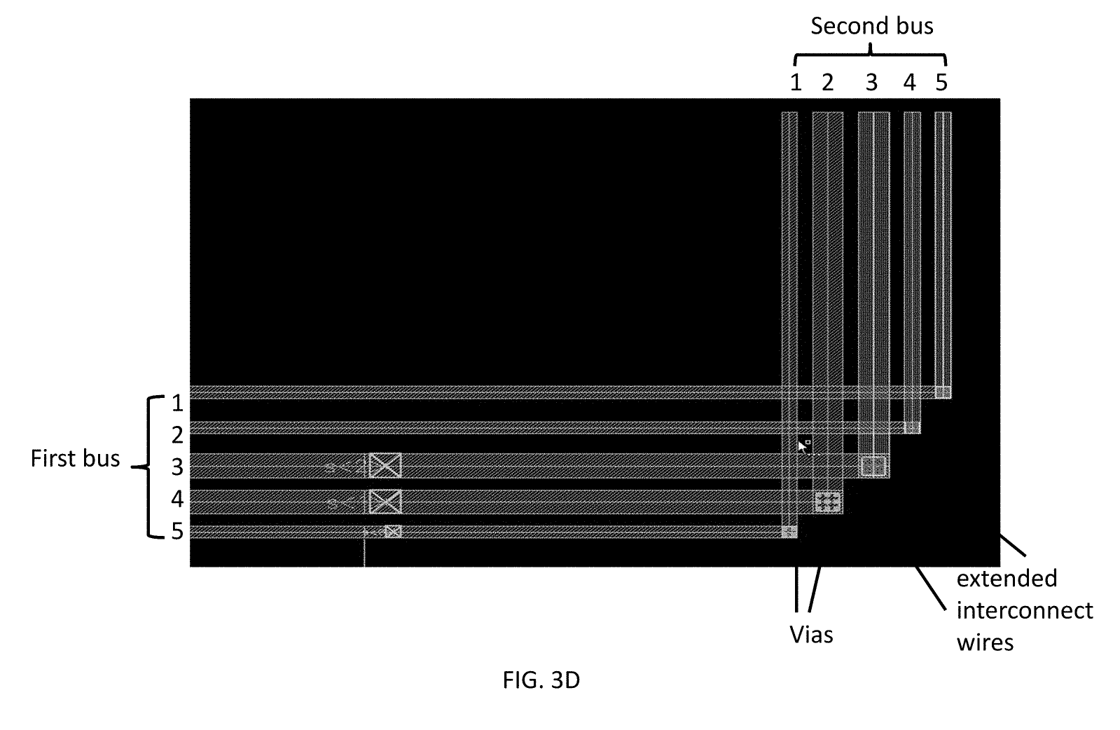

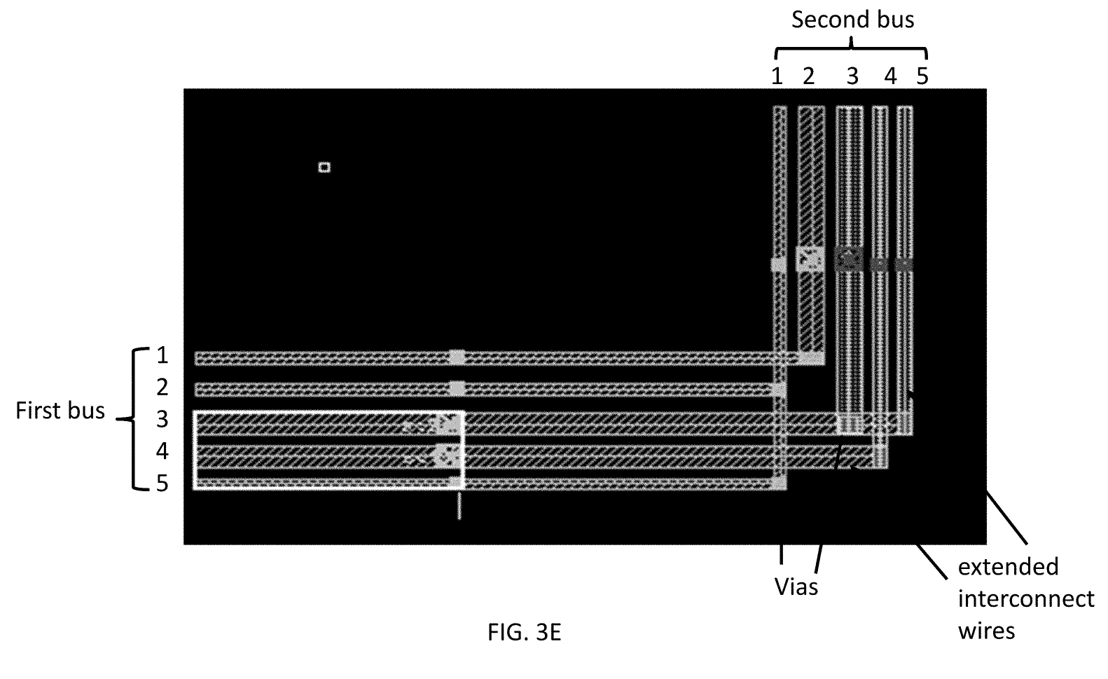

In the example of FIG. 1, the layout objects group identification component 108 of the graphic-based layout editor 104 is configured to recognize a directional and continuous cursor movement by a user along a first single line from a starting point to an ending point in the layout, wherein the first single line intersects with a first group of layout objects in the layout. Here, the user may initiate and perform the cursor movement via an input device (e.g., a mouse) of the host or by moving his/her finger across a touch screen of the host. The single line of directional continuous cursor movement from the starting point to the ending section across the layout can be in the form of one of a directed straight line, a directed curved line, or a directed line following a path of cursor movement across the layout. Since the single line is directional, the layout objects group identification component 108 is also configured to identify an order of the layout objects in the selected group based on the order they intersect with the directed single line. In the example where the identified group of layout objects is a bus, the layout objects group identification component 108 is further configured to identify a first selected ending section of the bus that is closer to the first single line than the other ending section of the bus. FIG. 3A depicts an example of a directional and continuous cursor movement by the user along a first directed single line from a starting point to an ending point across a layout to select a first bus comprising five interconnect wires, wherein the first directed single line intersects with and selects one ending section of the first bus. In some embodiments, the layout objects in the first group of layout objects identified by the layout objects identification component 108 share at least some of their geometric properties. For the non-limiting example depicted in FIG. 3A, the five interconnect wires in the identified first bus have the same topology but different wire widths and spacing among them.

Following the identification of the first group of layout objects, the layout objects group identification component 108 is configured to recognize another directional and continuous cursor movement by the user along a second directed single line from a starting point to an ending point in the layout in a similar fashion, wherein the second single line intersects with a second group of layout objects in the layout at a second section. FIG. 3B depicts an example of a directional and continuous cursor movement by the user along a second directed single line from a starting point to an ending point across a layout to select a second bus also comprising five interconnect wires, wherein the second single line intersects with and selects one ending section of the second bus. Here, although the number of interconnect wires in both the first and the second buses are the same, the interconnect wires in the second bus may be on one or more different layers from the layer(s) of the interconnect wires in the first bus.

Once the sections of the groups of layout objects have been selected via the directional and continuous cursor movements, the layout objects group operation component 110 of the graphic-based layout editor 104 is configured to retrieve metadata and/or one or more design rules associated with the selected groups of layout objects from the layout database 112. The layout objects group operation component 110 is then configured to perform a layout operation on the selected sections of the layout objects in the groups all at once based on the retrieved metadata and/or design rules. In some embodiments, the layout operation performed by the layout objects group operation component 110 also takes into account the order by which the layout objects within each group are selected, e.g., the layout operation is performed on the first layout object selected in the first group with respect to the first layout object selected in the second group, etc. FIG. 3C depicts an example of a bus connecting operation, which connects the corresponding interconnect wires at the selected ending sections of the first and the second buses as shown in FIGS. 3A and 3B together in the same order as the interconnect wires are selected (e.g., the first interconnect wire selected in the first group is connected to the first interconnect wire selected in the second group, the second interconnect wire selected in the first group is connected to the second interconnect wire selected in the second group, etc.) by extending the interconnect wires in both groups on their respective layers and connecting them together via a plurality added vias across their different layers.

In some embodiments, instead of connecting the layout objects in the groups in the order they are selected, the layout objects group operation component 110 is configured to connect the corresponding interconnect wires at the selected sections of the first and the second groups of layout objects together in the reverse order as the interconnect wires are selected (e.g., the first interconnect wire selected in the first group is connected to the last interconnect wire selected in the second group, the last interconnect wire selected in the first group is connected to the first interconnect wire selected in the second group, etc.). FIG. 3D depicts an example of a bus connecting operation, which connects the corresponding interconnect wires at the selected ending sections of the first and the second buses as shown in FIGS. 3A and 3B together in the reverse order as they are selected by extending the interconnect wires in both groups on their respective layers and connecting them together via a plurality added vias across their different layers.

In some embodiments, the layout objects group operation component 110 is configured to connect the corresponding interconnect wires at the selected ending sections of the first and the second buses as shown in FIGS. 3A and 3B together based on the identifications or names of the interconnect wires, wherein interconnect wires that are associated with the same identification (e.g., same net Id, name, or label in the IC layout) are connected together. FIG. 3E depicts an example of a bus connecting operation, which connects the corresponding interconnect wires at the selected ending sections of the first and the second buses as shown in FIGS. 3A and 3B together based on net names of the interconnect wires. As shown by the example of FIG. 3E, interconnect wires #2 and #5 in the first bus belong to the same net as interconnect wire #1 in the second bus and they are thus connected together, while interconnect wire #3 in the first bus belongs to the same net as interconnect wires #3 and #5 in the second bus and they are thus connected together. In some embodiments, the graphic-based layout editor 104 is configured to enable the user to specify or label one or more of the interconnect wires in the buses so that the interconnect wires sharing the same identification, name, or label can be connected together.

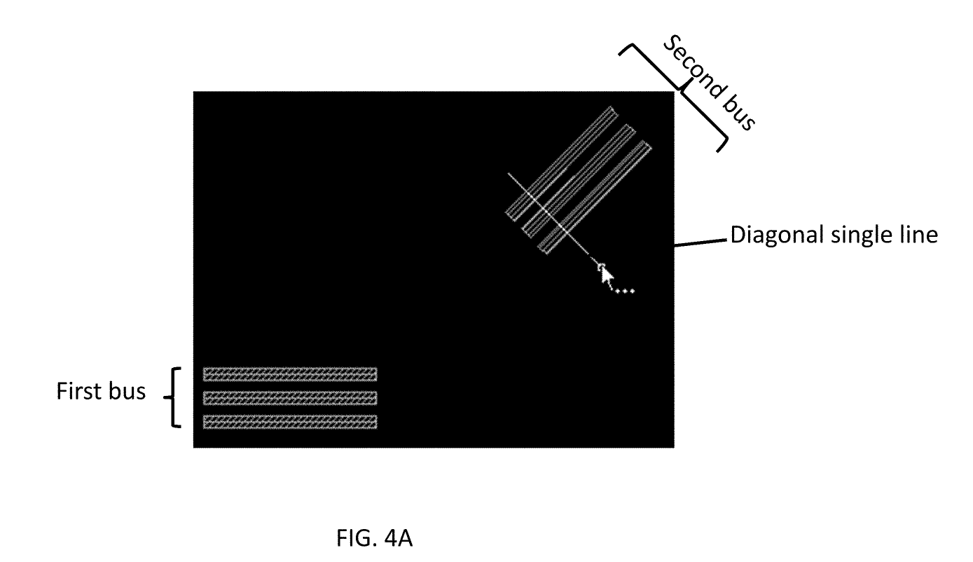

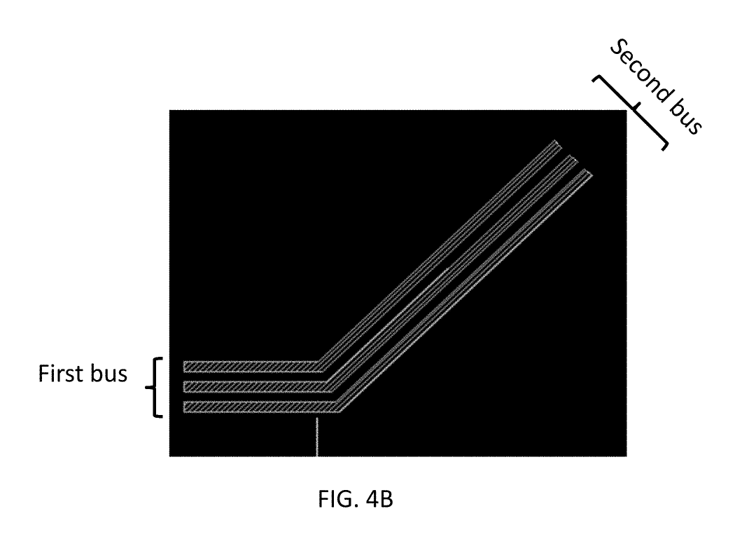

In some embodiments, the layout objects group identification component 108 is configured to recognize directional and continuous cursor movements by the user along single lines in any directions in the layout, wherein such directions are not limited to horizontal or vertical lines, and identify multiple groups of layout objects in any orientation or angle with respect to each other. FIG. 4A depicts an example of two buses selected by directional and continuous cursor movements by the user, wherein the second bus is selected by a diagonal single line unparalleled to the horizontal or vertical direction. The layout objects group operation component 110 is then configured to connect the two buses at an arbitrary angle or orientation with respect to each other as shown in FIG. 4A together on different or the same layer as depicted by the example of FIG. 4B.

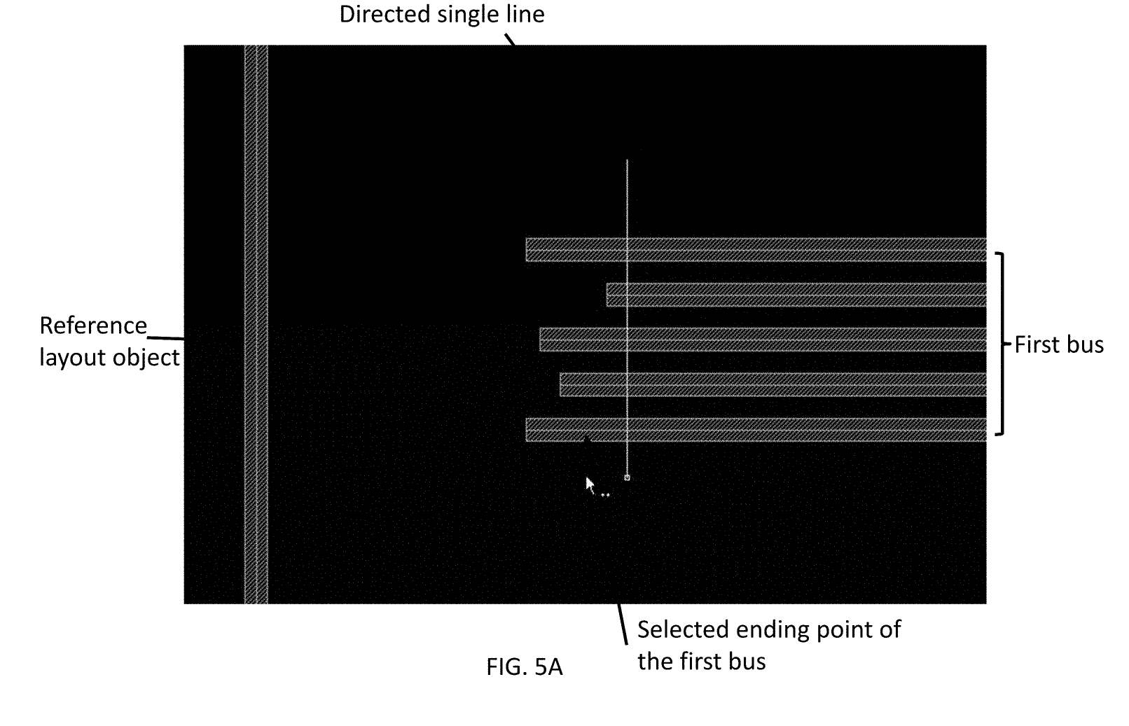

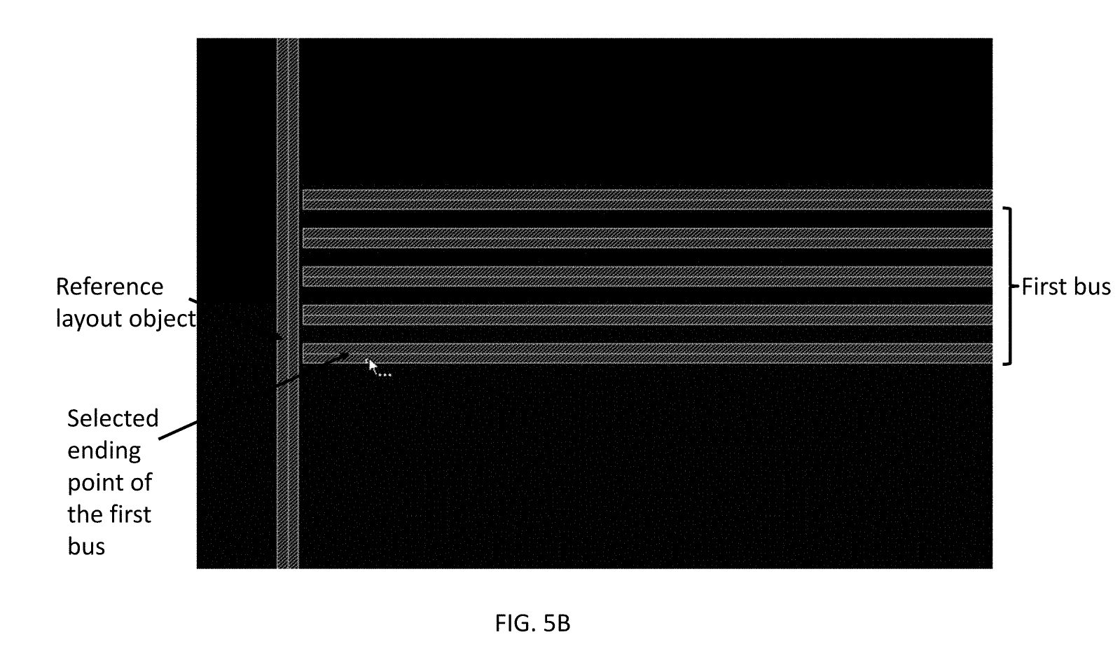

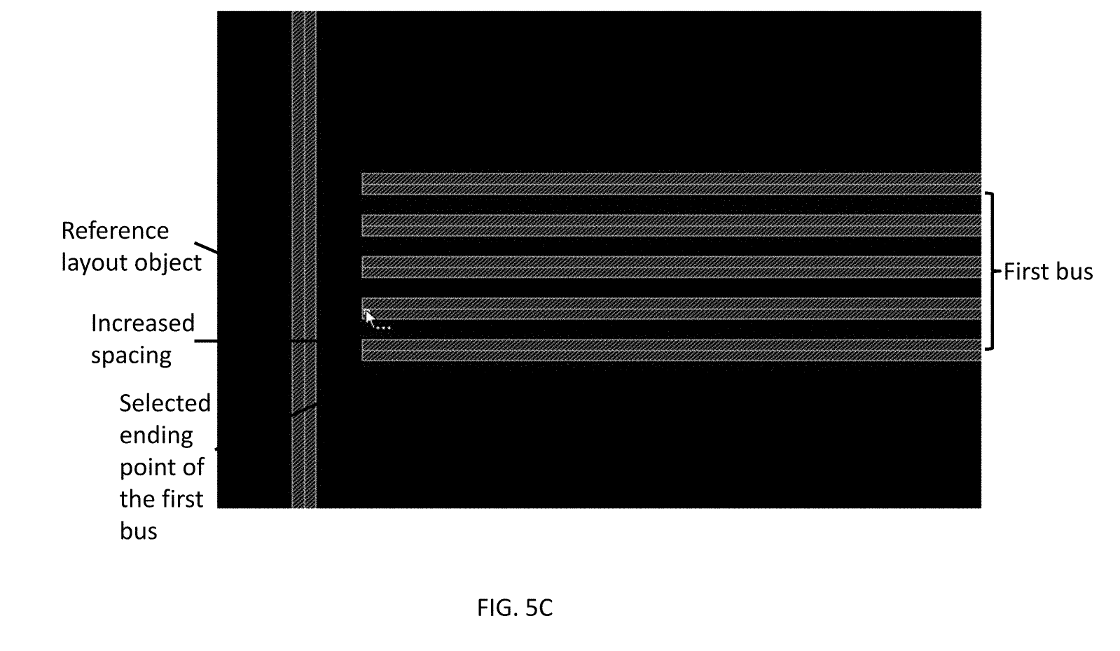

In some embodiments, the layout objects group operation component 110 is configured to perform a layout operation on the selected first group of layout objects using the selected second group of one or more layout objects as a reference point. FIG. 5A depicts an example of a first group of layout objects (e.g., a bus) selected by a directional and continuous cursor movement by the user along a directed single line across a layout, wherein the single line intersects with and selects one ending section of the bus. A second group of one layout object is also selected as a reference layout object, which is perpendicular to the first group of layout objects. The layout objects group operation component 110 is configured to perform an alignment operation at all layout objects in the first bus at the same time to align the selected ending section of the first bus as shown in FIG. 5A with respect to the reference layout object in the second group as shown by the example of FIG. 5B, wherein the spacing between the first bus and the reference layout object is at a minimum spacing required by design rules. FIG. 5C depicts an example of an alignment operation in the opposite direction wherein the first bus is “pushed away” from the reference layout object in the second group with spacing between the two groups increasing from the minimum spacing to a spacing specified by the user.

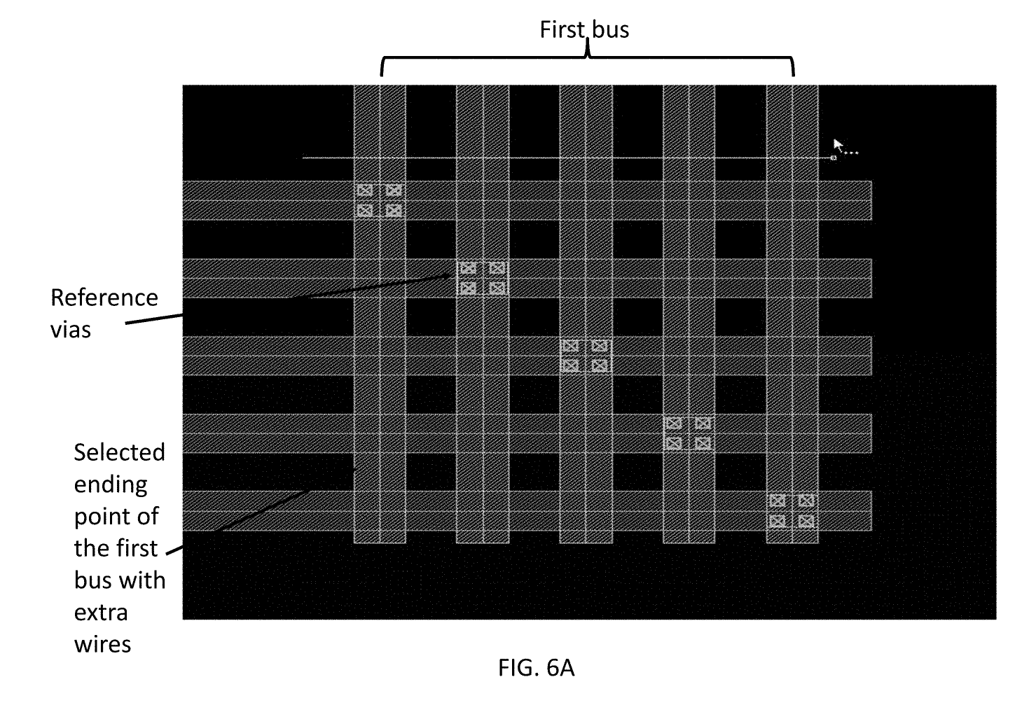

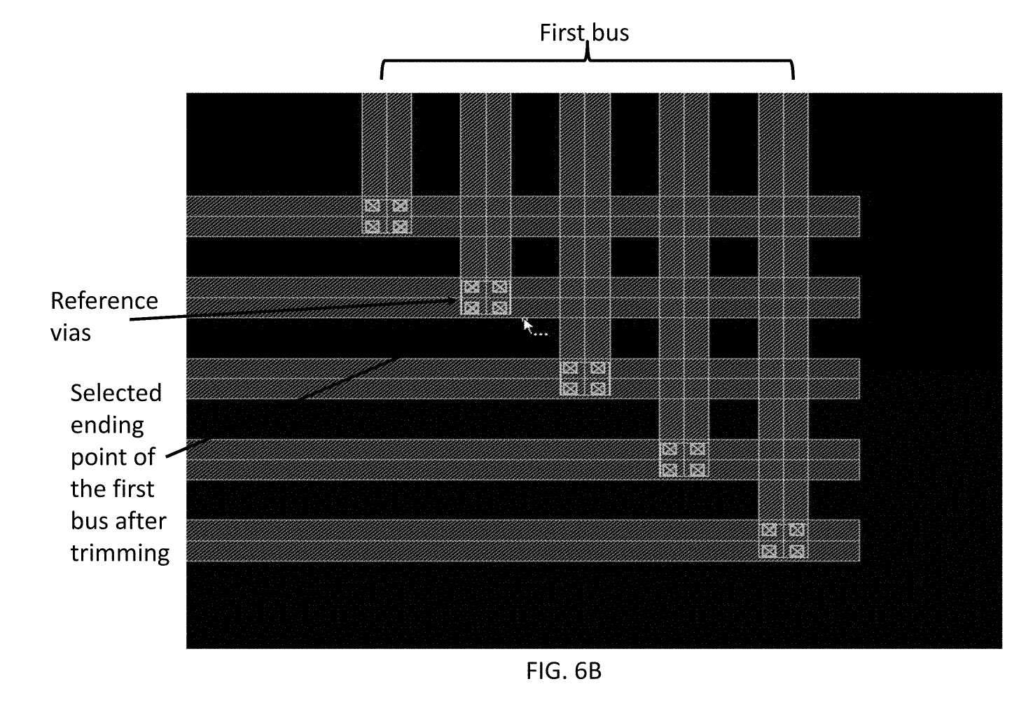

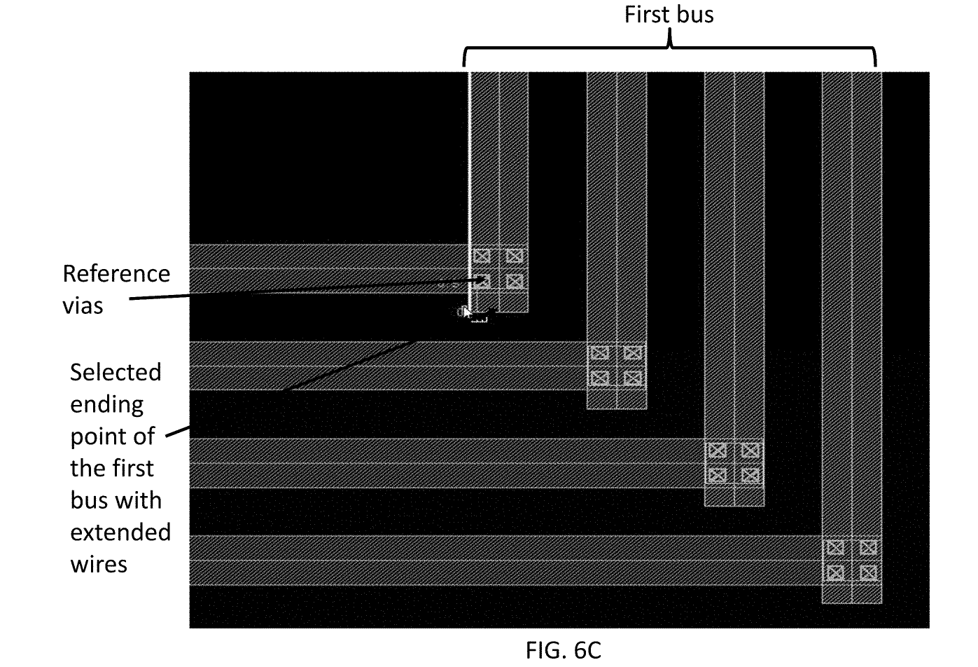

In some embodiments, the layout objects group identification component 108 is configured to identify a first group of layout objects (e.g., a bus) having extra wires extended beyond a second group of layout objects (e.g., vias) at a selected ending section of the second group as shown by the example of FIG. 6A. The layout group operation component 110 is then configured to perform a trimming operation at the selected ending section of all layout objects in the first group shown in FIG. 6A at the same time to trim off the extra wires to the corresponding positions of the vias in the second group, which serve as the reference point for the wire trimming operation as shown by the example of FIG. 6B. In some embodiments, the layout group operation component 110 is configured to extend the selected ending section of all layout objects in the first group at the same time to a certain length beyond the corresponding positions of the reference vias in the second group as shown by the example of FIG. 6C, wherein the length of the extension is either as required by design rules or as specified by the user.

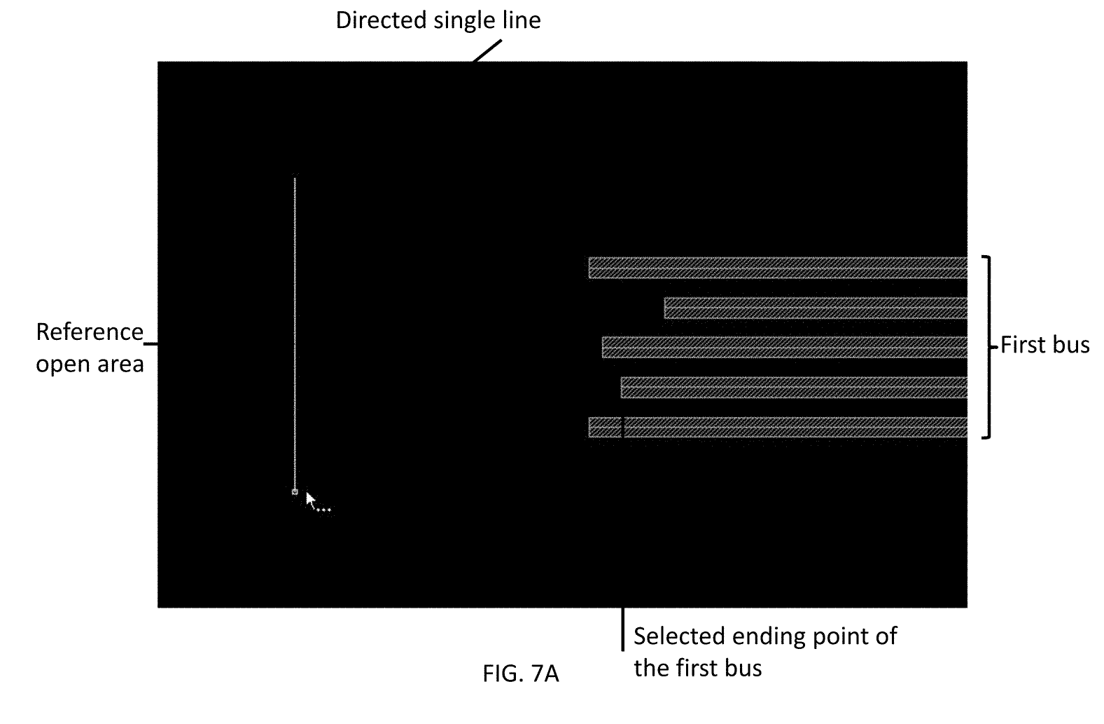

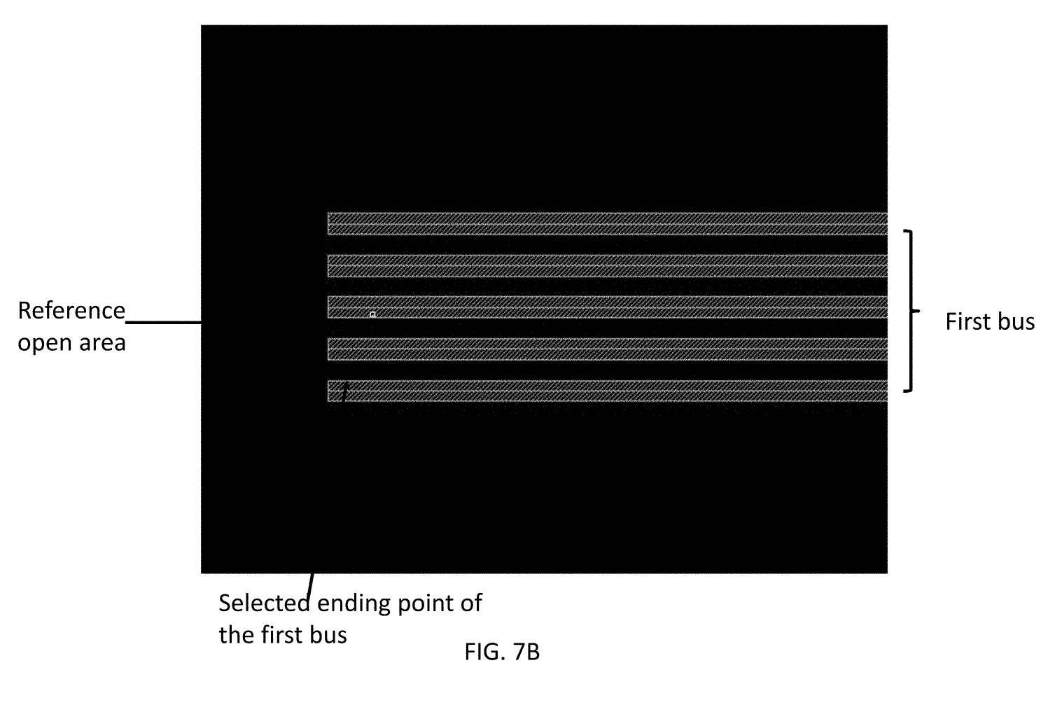

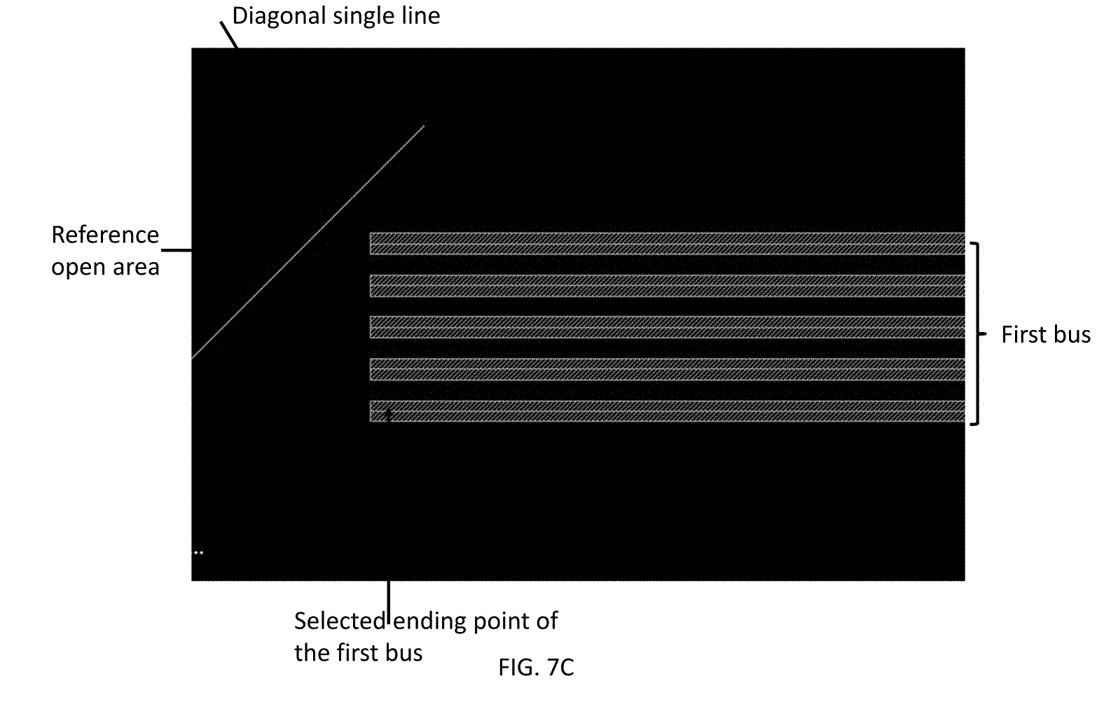

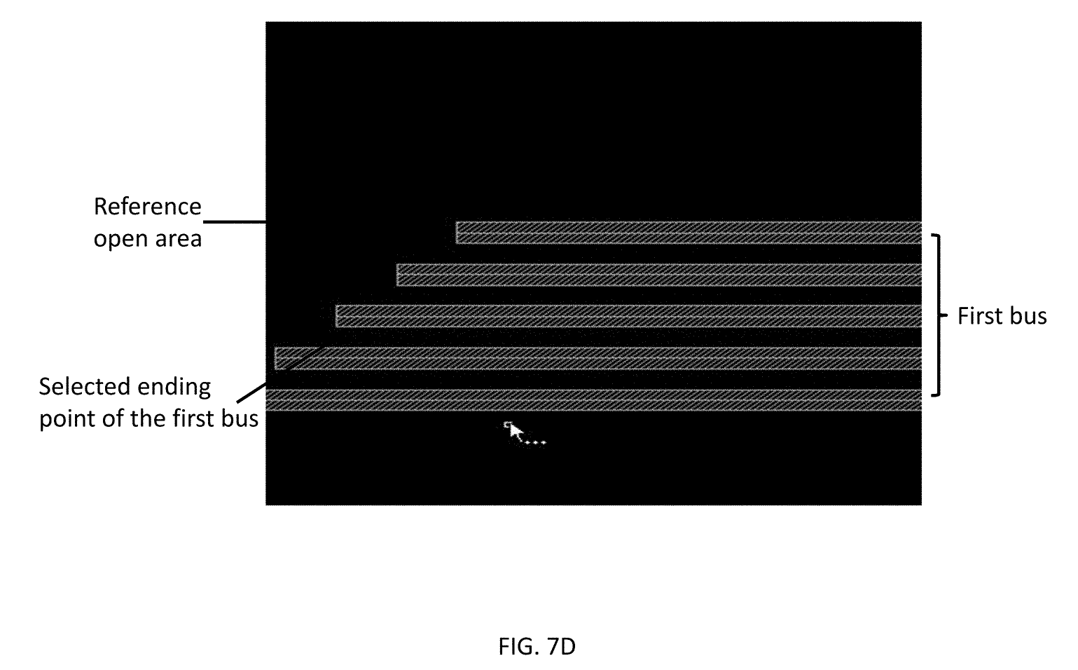

In some embodiments, the layout objects group operation component 110 is configured to perform a layout operation on the selected first group of layout objects using a selected second group comprising an open area in the layout as the reference point. FIG. 7A depicts an example of an open space in the layout selected by a directed single line as the reference point for the first bus to which a layout operation is to be performed. FIG. 7B depicts an example of an alignment operation at all layout objects in the first bus at the same time to align the selected ending section of the first bus with respect to the selected reference point of open area in the layout depicted in FIG. 7A, wherein the spacing between the first bus and the reference open area is at either a minimum spacing required by design rules or a spacing specified by the user. In some embodiments, the reference layout object or the reference open area in the second group can be selected by a diagonal single line unparalleled to the horizontal or vertical direction. FIG. 7C depicts an example of an open space in the layout selected by a diagonal single line as the reference point for the first bus to which a layout operation is to be performed. FIG. 7D depicts an example of an alignment operation at all layout objects in the first bus at the same time to align the selected ending section of the first bus with respect to the diagonally selected reference open area in the layout at either a minimum spacing required by design rules or a spacing specified by the user.

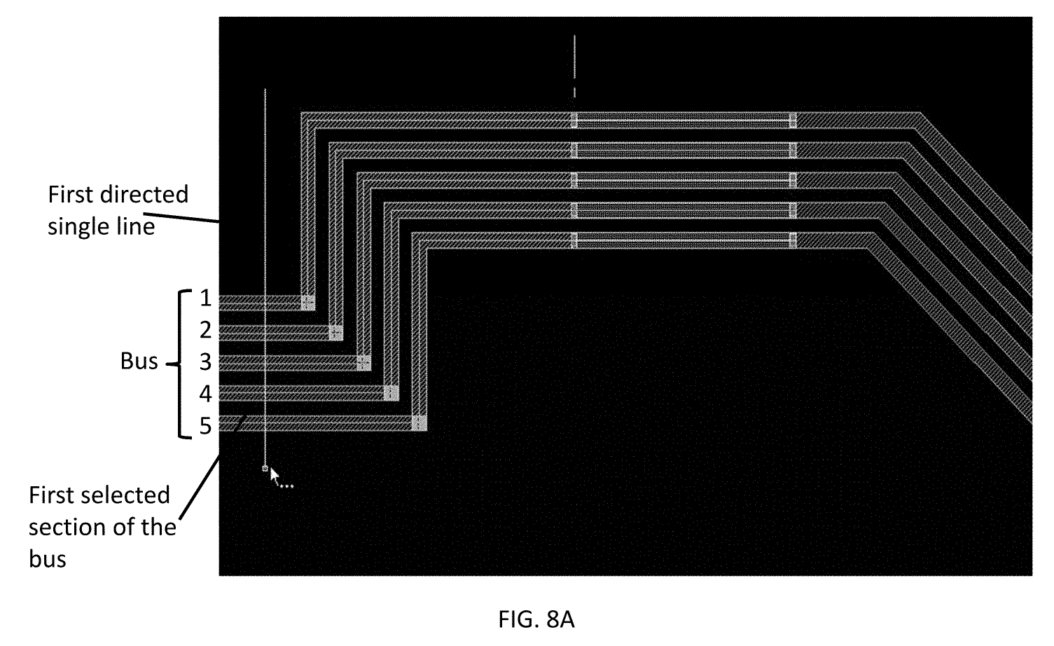

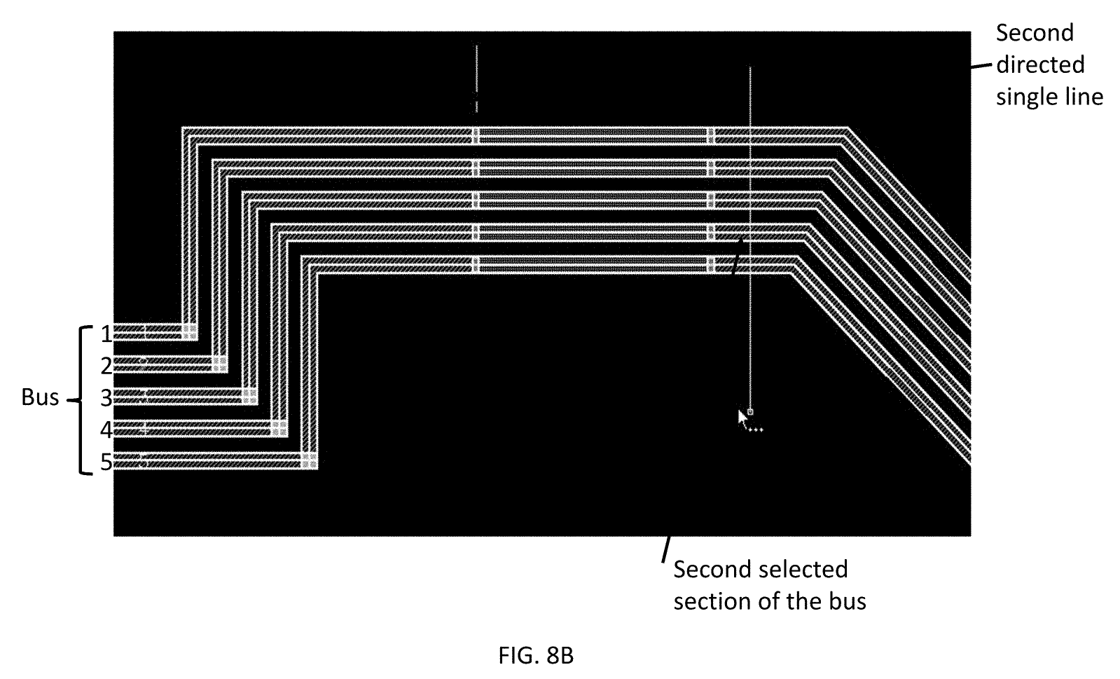

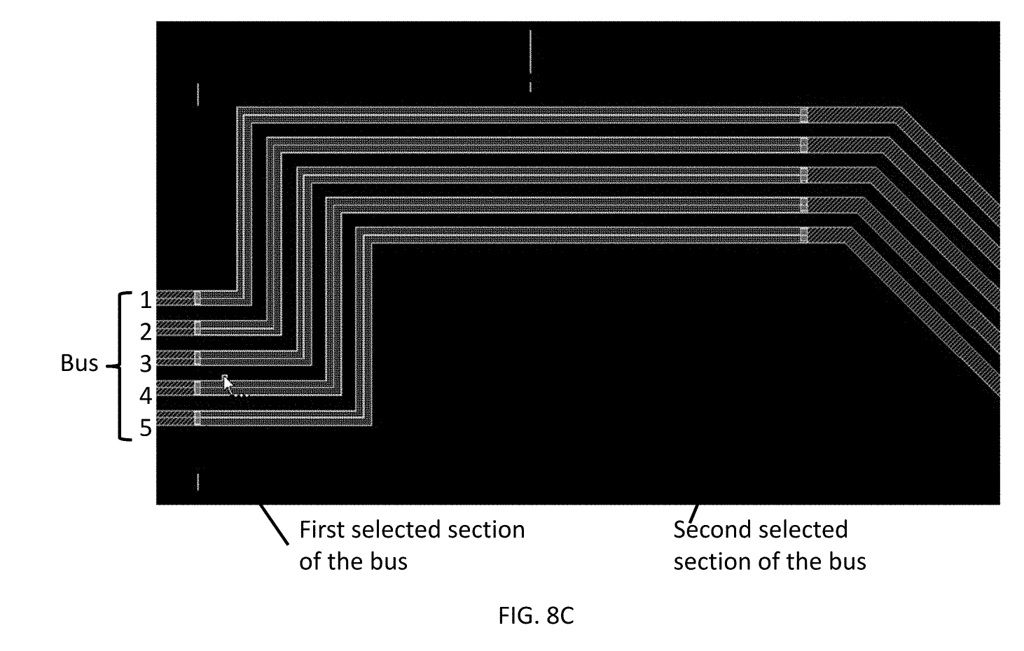

In some embodiments, the layout objects group identification component 108 is configured to identify multiple sections of a group of layout objects by recognizing multiple single lines of directional and continuous cursor movements across the layout, wherein the single lines intersect with the group of layout objects at the multiple sections, respectively. FIG. 8A depicts an example of a group of layout objects, e.g., a bus, comprising a plurality of interconnect wires sharing the same topology and each having a plurality of interconnect wire segments on a plurality of layers connected by vias. A first directed single line of directional and continuous cursor movement across the bus intersects with and selects a first section of the bus. A second directed single line of directional and continuous cursor movement across the bus intersects with and selects a second section of the bus as shown by the example of FIG. 8B. Once the sections of the group of layout objects have been identified, the layout objects group operation component 110 is configured to perform a layout operation between the selected sections of the group of layout objects. In the example depicted in FIG. 8C, the layout objects group operation component 110 is configured to perform a wire replacing or “bridging” operation between the two selected sections of the bus as shown in FIGS. 8A and 8B by replacing the existing interconnect wire segments and vias between the two selected sections with a new set of interconnect wire segments and/or vias. In some embodiments, the new interconnect wire segments can be on a different layer from the existing interconnect wire segments they replace to allow routing of wires on a layer under or above the layer of the new interconnect wire segments.

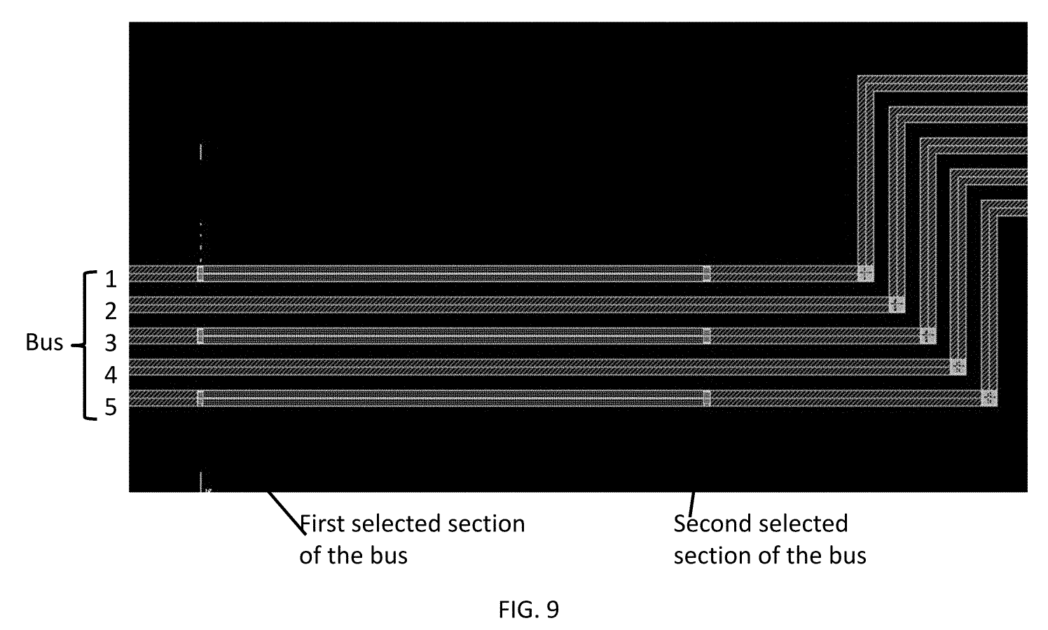

In some embodiments, the layout objects group operation component 110 is configured to perform a layout operation on a subset, but not all, of the layout objects in the group between the selected sections of the group of layout objects. Here, the subset of the layout objects can be chosen based on one or more of, for non-limiting examples, identifications, labels, relative positions, ranks, or orders of the layout objects in the group. FIG. 9 depicts an example of a “bridging” operation performed between the first and the second selected sections of a bus. Instead of performing the operation for all interconnect wires between the two selected sections in the bus, the “bridging” operation is only performed on odd-ranked interconnect wires (e.g., interconnect wires #1, 3, and 5) in the bus by replacing the existing interconnect wire segments of the odd-ranked interconnect wires with new interconnect wire segments on a different layer to reduce noise and crosstalk between the interconnect wires in the bus in the IC layout.

Once the layout operation on the group(s) of layout objects is completed, the layout display component 106 is configured to present the edited group(s) of layout objects on the display, update the metadata (e.g., width, size, spacing, topology, location, and/or connections) of each of the layout objects in the group(s) that have been affected by the layout operation, and save the group(s) of layout objects to the layout database 112 together with their updated metadata.

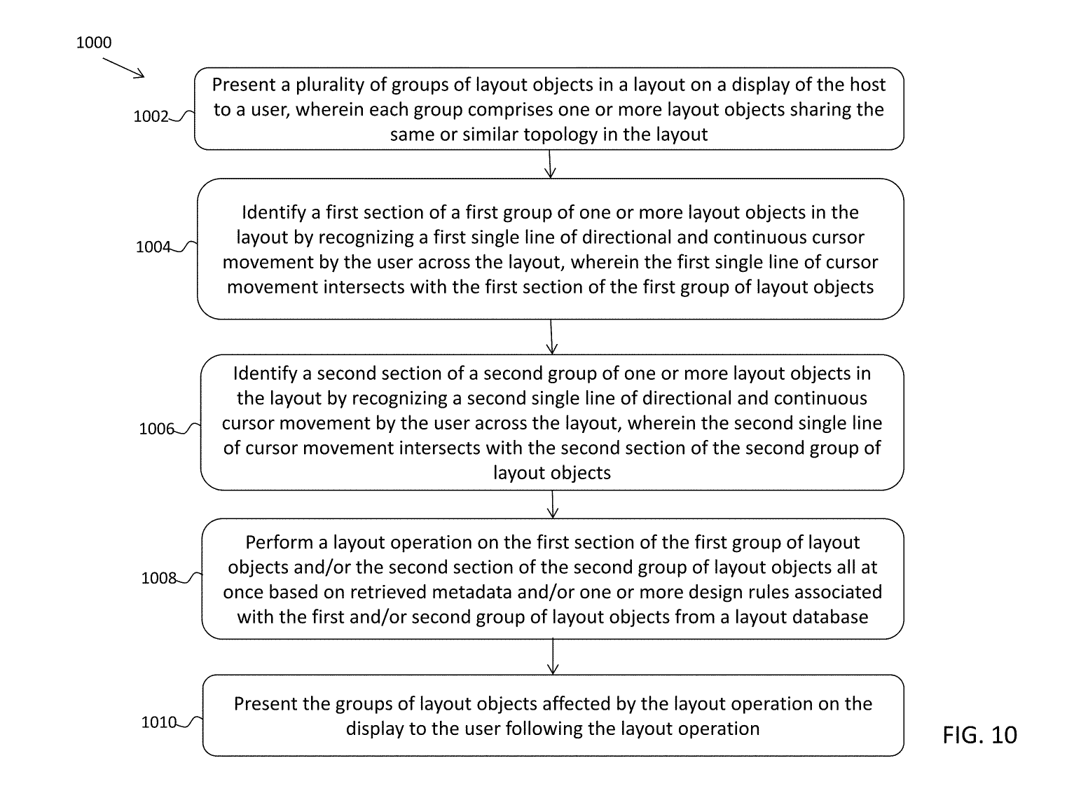

FIG. 10 depicts an example of a flowchart of a process to support selection and operation on multiple groups of layout objects. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 10, the flowchart 1000 starts at block 1002, where a plurality of groups of layout objects in a layout are presented on a display of the host to a user, wherein each group comprises one or more layout objects sharing the same or similar topology in the layout. The flowchart 1000 continues to block 1004, where a first section of a first group of one or more layout objects in the layout is identified by recognizing a first single line of directional and continuous cursor movement by the user across the layout, wherein the first single line of cursor movement intersects with the first section of the first group of layout objects. The flowchart 1000 continues to block 1006, where a second section of a second group of one or more layout objects in the layout is identified by recognizing a second single line of directional and continuous cursor movement by the user across the layout, wherein the second single line of cursor movement intersects with the second section of the second group of layout objects. The flowchart 1000 continues to block 1008, where a layout operation is performed on the first section of the first group of layout objects and/or the second section of the second group of layout objects all at once based on retrieved metadata and/or one or more design rules associated with the first and/or second group of layout objects from a layout database. The flowchart 1000 ends at block 1010, where the groups of layout objects affected by the layout operation are presented on the display to the user following the layout operation.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVDs, CD-ROMs, micro drives, magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments, and the various modifications that are suited to the particular use contemplated.

What is claimed is:

1. A system to support selection and operation on multiple groups of layout objects, comprising:
a graphic-based layout editing tool running on a host, which in operation, is configured to
present a plurality of groups of layout objects in a layout on a display of the host to a user, wherein each group comprises one or more layout objects sharing the same or similar topology in the layout;
identify a first section of a first group of one or more layout objects in the layout by recognizing a first single line of directional and continuous cursor movement by the user across the layout, wherein the first single line of cursor movement intersects with the first section of the first group of layout objects;
identify a second section of a second group of one or more layout objects in the layout by recognizing a second single line of directional and continuous cursor movement by the user across the layout, wherein the second single line of cursor movement intersects with the second section of the second group of layout objects;
perform a layout operation on the first section of the first group of layout objects and/or the second section of the second group of layout objects all at once based on retrieved metadata and/or one or more design rules associated with the first and/or second group of layout objects from a layout database;
present the groups of layout objects affected by the layout operation on the display to the user following the layout operation.

2. The system of claim 1, further comprising:
said layout database configured to maintain metadata and/or design rules associated with each of the layout objects in the layout, wherein the metadata of each layout object includes one or more of name, identifier, and geometric properties of the layout object as well as its connections to other layout objects, wherein the geometric properties include width, size, and topology of the layout object, and the design rules include one or more of minimum and/or maximum width and/or length of the layout object, minimum and/or maximum spacing between the layout object and its adjacent layout objects, and a specific layer the layout object needs to be placed.

3. The system of claim 1, wherein:
each of the first and the second single lines of cursor movement is one of a directed straight line, a directed curved line, or a directed line following a path of cursor movement across the layout.

4. The system of claim 1, wherein:
the graphic-based layout editing tool is configured to perform the layout operation on the layout objects within each group in the order the layout objects are selected in each group.

5. The system of claim 1, wherein:
the graphic-based layout editing tool is configured to perform the layout operation on the layout objects within each group in the reverse order the layout objects are selected in each group.

6. The system of claim 1, wherein:
the graphic-based layout editing tool is configured to perform the layout operation on the layout objects within each group based on identifications or names of the layout objects in each group.

7. The system of claim 1, wherein:
the graphic-based layout editing tool is configured to recognize a directional and continuous cursor movement by the user along a single line in a direction unparalleled to horizontal or vertical direction.

8. The system of claim 1, wherein:
the graphic-based layout editing tool is configured to perform the layout operation on the layout objects within the selected first group using the selected second group of one or more layout objects as a reference point.

9. The system of claim 8, wherein:
the second group comprising an open area in the layout as the reference point.

10. The system of claim 8, wherein:
the graphic-based layout editing tool is configured to trim extra portions of the layout objects in the first group using the layout objects in the second group as the reference point.

11. The system of claim 1, wherein:
the graphic-based layout editing tool is configured to
identify a plurality of sections of one group of layout objects instead of multiple groups of layout objects by recognizing a plurality of single lines of directional and continuous cursor movements across the layout, wherein the single lines intersect with the group of layout objects at the plurality of sections, respectively;
perform the layout operation between the identified sections of the same group of layout objects.

12. The system of claim 1, wherein:
the graphic-based layout editing tool is configured to perform the layout operation on a subset, but not all, of the layout objects within each group of the layout objects.

13. A computer-implemented method to support layout objects selection and replication, comprising:
presenting a plurality of groups of layout objects in a layout on a display of the host to a user, wherein each group comprises one or more layout objects sharing the same or similar topology in the layout;
identifying a first section of a first group of one or more layout objects in the layout by recognizing a first single line of directional and continuous cursor movement by the user across the layout, wherein the first single line of cursor movement intersects with the first section of the first group of layout objects;
identifying a second section of a second group of one or more layout objects in the layout by recognizing a second single line of directional and continuous cursor movement by the user across the layout, wherein the second single line of cursor movement intersects with the second section of the second group of layout objects;
performing a layout operation on the first section of the first group of layout objects and/or the second section of the second group of layout objects all at once based on retrieved metadata and/or one or more design rules associated with the first and/or second group of layout objects from a layout database;
presenting the groups of layout objects affected by the layout operation on the display to the user following the layout operation.

14. The computer-implemented method of claim 13, further comprising:
performing the layout operation on the layout objects within each group in the order the layout objects are selected in each group.

15. The computer-implemented method of claim 13, further comprising:
performing the layout operation on the layout objects within each group in the reverse order the layout objects are selected in each group.

16. The computer-implemented method of claim 13, further comprising:
performing the layout operation on the layout objects within each group based on identifications or names of the layout objects in each group.

17. The computer-implemented method of claim 13, further comprising:
recognizing a directional and continuous cursor movement by the user along a single line in a direction unparalleled to horizontal or vertical direction.

18. The computer-implemented method of claim 13, further comprising:
performing the layout operation on the layout objects within the selected first group using the selected second group of one or more layout objects as a reference point.

19. The system of claim 18, wherein:
the second group comprising an open area in the layout as the reference point.

20. The computer-implemented method of claim 18, further comprising:
trimming extra portions of the layout objects in the first group using the layout objects in the second group as the reference point.

21. The computer-implemented method of claim 13, further comprising:
identifying a plurality of sections of one group of layout objects instead of multiple groups of layout objects by recognizing a plurality of single lines of directional and continuous cursor movements across the layout, wherein the single lines intersect with the group of layout objects at the plurality of sections, respectively;
performing the layout operation between the identified sections of the same group of layout objects.

22. The computer-implemented method of claim 13, further comprising:
performing the layout operation on a subset, but not all, of the layout objects within each group of the layout objects.

23. A non-transitory computer readable storage medium having software instructions stored thereon that when executed cause a system to:
present a plurality of groups of layout objects in a layout on a display of the host to a user, wherein each group comprises one or more layout objects sharing the same or similar topology in the layout;
identify a first section of a first group of one or more layout objects in the layout by recognizing a first single line of directional and continuous cursor movement by the user across the layout, wherein the first single line of cursor movement intersects with the first section of the first group of layout objects;
identify a second section of a second group of one or more layout objects in the layout by recognizing a second single line of directional and continuous cursor movement by the user across the layout, wherein the second single line of cursor movement intersects with the second section of the second group of layout objects;
perform a layout operation on the first section of the first group of layout objects and/or the second section of the second group of layout objects all at once based on retrieved metadata and/or one or more design rules associated with the first and/or second group of layout objects from a layout database;
present the groups of layout objects affected by the layout operation on the display to the user following the layout operation.
